(19) United States
(12) Patent Application Publication
(10) Pub. No.: US 2014/0285723 A1
(43) Pub. Date: Sep. 25, 2014

(54) MULTIPLE ANTENNA ATSC HDTV RECEIVER DEVICE

(71) Applicant: Lin Yang, (US)

(72) Inventor: Lin Yang, Milpitas, CA (US)

(21) Appl. No.: 13/872,917

(22) Filed: Apr. 29, 2013

Related U.S. Application Data
(60) Provisional application No. 61/805,108, filed on Mar. 25, 2013.

(51) Int. Cl. H04B 1/00; H04H 40/18; H04N 5/44; H04B 1/18

(52) U.S. Cl. CPC H04B 1/0064; H04B 1/18; H04H 40/18; H04N 5/4401
USPC 348/731

(57) ABSTRACT

A device is provided. The device comprises of Signal-to-noise ratio (SNR) Weighted Combining for multiple antennas, Frequency Domain Maximum Ratio Combining (MRC) Equalizer, Time Domain Maximum Ratio Combining (MRC) Equalizer, Equal Gain Combining Unit, and Selective Combining Slicer. The method for producing the device is also provided.

This application claims the benefit of the U.S. Provisional application No. 61805108, filed Mar. 25, 2013.

### TECHNICAL FIELD

The present invention relates generally to an application in a digital television system, more specifically the present invention relates to a multiple antenna ATSC terrestrial DTV receiver for indoor and mobile users.

### BACKGROUND

Single carrier terrestrial digital television (DTV) systems (ATSC) are deployed in the countries such as United States, Canada, and other countries.

ATSC HDTV signals are subject to multipath with Doppler interference in indoor, outdoor, and mobile environments.

Currently, only single-antenna ATSC HDTV receivers exist. For existing single-antenna applications, an equalizer can be used to remove the static multipath interference.

To improve reception, multiple antennas should be used. However, no existing ATSC HDTV receiver can efficiently combine multiple antenna signals to make it perform better than a single antenna. This is because the multiple Doppler multipath generated by the multiple antennas are cross-interfering.

This invention is a means to build a receiver device that optimally combines the signals from multiple antennas, which removes multiple multipath (with or without Doppler) interference and enhances the ATSC HDTV signal reception in indoor, outdoor, and mobile environments.

The following patents are herein incorporated by reference: U.S. patent application Ser. No. 12/512,901 entitled A NOVEL EQUALIZER FOR SINGLE CARRIER TERRESTRIAL DTV RECEIVER, by Yang; U.S. patent application Ser. No. 12/554,925 entitled A MULTIPLE TUNER ATSC TERRESTRIAL RECEIVER FOR INDOOR & MOBILE USERS, by Yang; U.S. patent application Ser. No. 12/572,236 entitled A MULTIPLE TUNER TERRESTRIAL DTV RECEIVER FOR INDOOR & MOBILE USERS, by Yang.

In addition to the above-referenced applications, the present invention adds the following functional blocks: A Function of Signal-to-noise ratio (SNR) Weighted Combining for multiple antennas, A Function of Frequency Domain Maximum Ratio Combining (MRC) Equalizer, A Function of A Time Domain Maximum Ratio Combining (MRC) Equalizer, A Function of Equal Gain Combining Unit, and A Function of Selective Combining Slicer.

### SUMMARY OF THE INVENTION

This invention is a Multiple Antenna ATSC HDTV Receiver Device, which comprises of the following functional blocks: Signal-to-noise ratio (SNR) Weighted Combining for multiple antennas, Frequency Domain Maximum Ratio Combining (MRC) Equalizer, Time Domain Maximum Ratio Combining (MRC) Equalizer, Equal Gain Combining Unit, and Selective Combining Slicer.

### BRIEF DESCRIPTION OF THE DRAWINGS

Having thus described the invention in general terms, reference will now be made to the accompanying drawings, which are not necessarily drawn to scale, and wherein:

FIG. 1 is the Multiple Antenna ATSC HDTV Receiver Device.

FIG. 2 is an adapter for a wired or wireless connection between the antennas and the combining device.

FIG. 3 is a Signal Combining Device for TV, Tablet, Phone, Set-Top-Box, etc.

### DETAILED DESCRIPTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

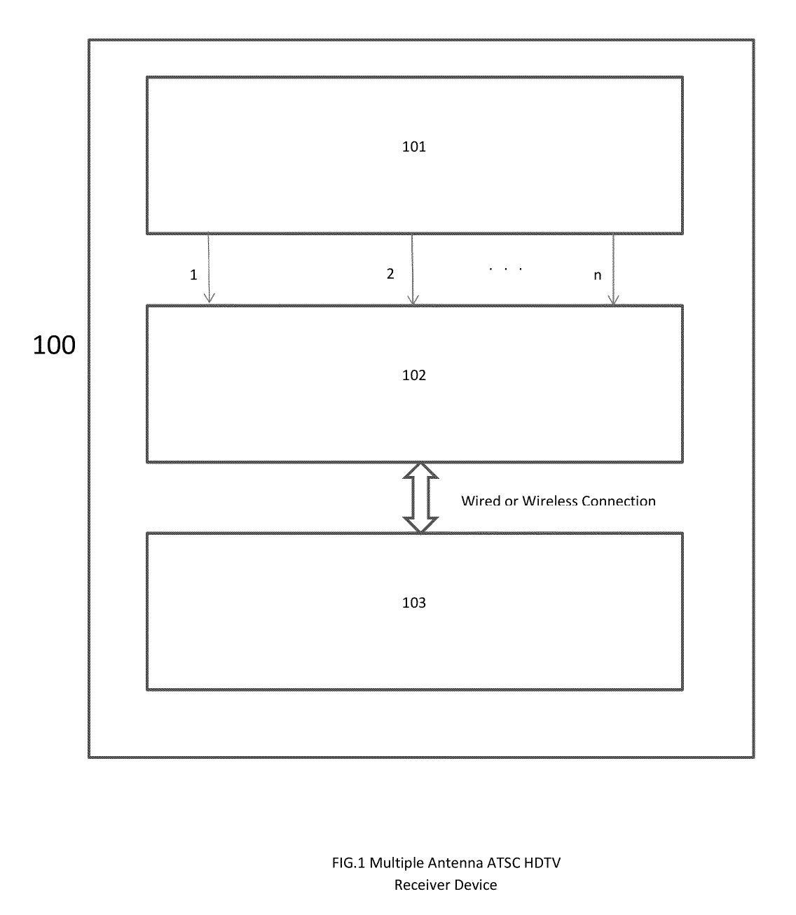

This invention is described in FIG. 1.

101 shows the multiple (one or more) antennas which generate the multiple antenna signals to be combined & processed.

102 is the means by which the multiple antenna signals from 101 are delivered to a combining device in 103.

103 is the signal combining device.

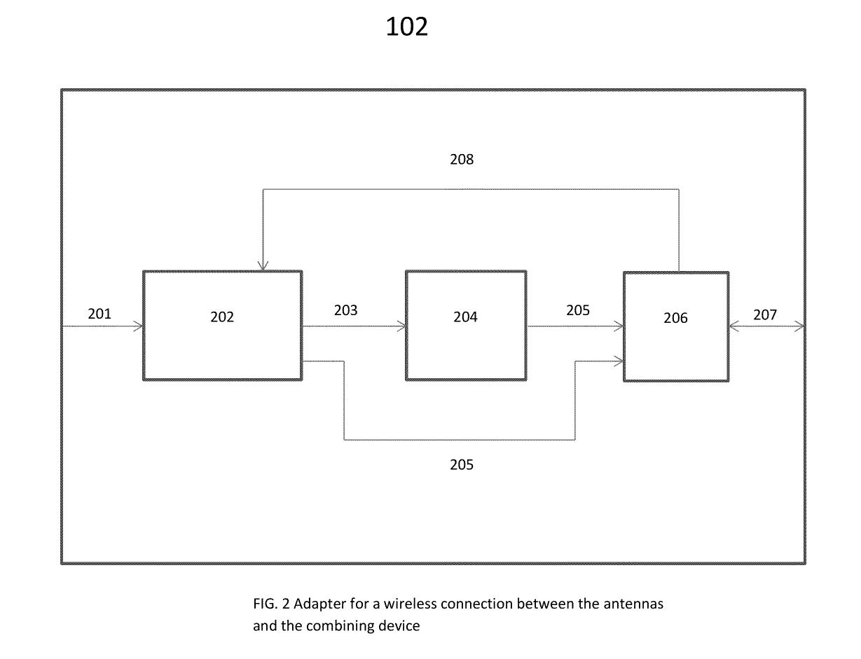

FIG. 2 shows 102, an adapter for a wired or wireless connection between the antennas and the combining device. This example is a newly invented wireless connection using only one of the multiple antennas. 201 is the RF signal from one of the multiple antennas. This signal will pass to a typical HDTV tuner, either CAN or silicon (202). This tuner will down-convert the RF signal to an IF signal in either analog (203) or digital (205) format.

204 is optional if the tuner only generates an analog IF signal.

The digital IF signal will be fed in to a high-speed Wi-Fi adapter capable of at least 200-300 Mbps (For example IEEE 11n, ac, ad, etc.). This generates a wireless RF signal. The automatic gain control (AGC) signals are fed back from 103 and are passed thru 206 to 202.

207 is a bi-directional signal. It includes multiple antenna digital IF signals to 103 and the automatic gain control (AGC) feedback signal from 103.

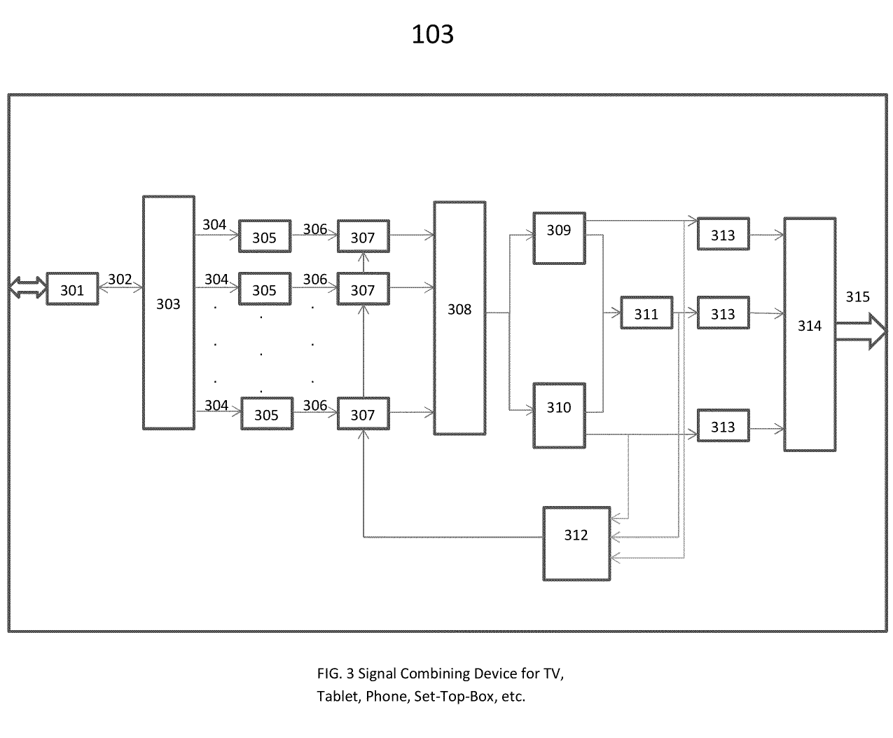

FIG. 3 shows 103, a Signal Combining Device for TV, Tablet, Phone, Set-Top-Box, etc. The example given is using the newly invented wireless connection option from 102.

301 converts the received Wi-Fi signal in to a multiplexed multiple antenna digital IF signals (302), feeds in to the demultiplexer (303), which generates a single antenna digital IF signal for each antenna (304).

Each digital IF signal (304) will feed in to 305. This generates a synchronized baseband signal for each antenna (306).

Given a baseband signal from each antenna (306), and the feedback signal from 312, 307 will estimate what the multipath channel looks like and analyze the multipath character and signal-to-noise ratio for each antenna.

Based on the results from each 307, 308 performs weighted combining for normalization of signal-to-noise ratio from multiple antennas based on a newly invented algorithm. This is a new component compared to existing single antenna ATSC HDTV receivers because multiple antennas require weighted combining prior to maximum ratio combining.

The weighted combined signal from 308 will feed in to both the newly invented frequency domain maximum ratio combining equalizer (309) and the newly invented time domain maximum ratio combining equalizer (310). Then, the results from the two equalizers (309 and 310) will be further combined using a newly invented equal gain combining unit (311) to generate an optimal time and frequency domain combined signal.

Now there are three signals from 309, 310 and 311—these three signals will pass through the newly invented selective combining slicer (312) to generate optimal feedback to 307. These three signals will also simultaneously pass thru 313 (feed forward path).

Now use the selective combining unit (314) to pick the best one output of the three (frequency, time, equal gain). Output will be MPEG TS (315).

What is claimed is:

1. A multiple antenna ATSC HDTV receiver device comprising of:
a. A Signal-to-noise ratio (SNR) Weighted Combining for multiple antennas,
b. A Frequency Domain Maximum Ratio Combining (MRC) Equalizer,
c. A Time Domain Maximum Ratio Combining (MRC) Equalizer,
d. An Equal Gain Combining Unit, and
e. A Selective Combining Slicer.

2. The device of claim 1 is associated with a single antenna being coupled to a plurality of ATSC TV tuners.

3. The device of claim 1 is associated with a plurality of antennas being coupled to a plurality of ATSC TV tuners.

4. The device of claim 1, wherein the device is used in a DTV receiver (e.g. TV, Set Top Box, etc.).

5. The device of claim 1, wherein the device is used in a mobile wireless receiver (e.g. Tablet, Cell Phone, Laptop, etc.).

6. A method providing:
a. A Function of Signal-to-noise ratio (SNR) Weighted Combining for multiple antennas,
b. A Function of Frequency Domain Maximum Ratio Combining (MRC) Equalizer,
c. A Function of A Time Domain Maximum Ratio Combining (MRC) Equalizer,
d. A Function of Equal Gain Combining Unit, and
e. A Function of Selective Combining Slicer.

7. The method of claim 6 is applied to a single antenna being coupled to a plurality of ATSC TV tuners.

8. The method of claim 6 is applied to a plurality of antennas being coupled to a plurality of ATSC TV tuners.

9. The method of claim 6 is applied to a DTV receiver (e.g. TV, Set Top Box, etc.).

10. The method of claim 6 is applied to a mobile wireless receiver (e.g. Tablet, Cell Phone, Laptop, etc.).
